(19) United States
(12) Patent Application Publication
(10) Pub. No.: US 2007/0256375 A1
(43) Pub. Date: Nov. 8, 2007

(54) Window having reinforcing structures for security film

(76) Inventor: Frank Fountas, Odessa, FL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/411,760

(22) Filed: Apr. 25, 2006

(51) Int. Cl. E06B 3/30

(52) U.S. Cl. 52/204.53

(57) ABSTRACT

The invention is directed to a glass anchoring system that reduces the potential for demounting the glass having a layer of security film when a severe impact force is applied to the glass. A pane of glass is secured within a frame assembly having a lower frame member, an upper frame member, a first side frame member and a second side frame member. A layer of security film is applied to a surface of the glass, typically the interior glass surface. The system includes a structural adhesive mass applied along the frame member and between opposed ends of the frame member. The structural mass has a first surface that contacts the security film and a second surface that contacts the frame member, wherein the first surface is oriented transversely to the second surface. The system further includes an elongated cover strip positioned against an exterior surface of the structural mass, wherein the cover strip has a lower edge portion that contacts the frame member and an upper edge portion that contacts the security film. To reduce the potential for glass demounting, the structural mass and the cover strip combine to adhere the security film to the lower frame member and to dissipate a severe impact force applied to the glass.

### CROSS-REFERENCE TO RELATED APPLICATIONS

Not applicable.

### FEDERALLY SPONSORED RESEARCH OR DEVELOPMENT

Not applicable.

### TECHNICAL FIELD

The invention relates to a glass anchoring system that reduces the chance that the glass, including a layer of security film, will become detached from the frame assembly under severe conditions. More specifically, the invention provides a system for anchoring glass covered with a layer of security film within a window or door frame assembly, wherein a structural adhesive mass and a cover strip are applied to both the security film and the frame member to reduce the likelihood of the glass demounting the frame assembly upon the application of an exterior force, such as from severe weather or explosion.

### BACKGROUND OF THE INVENTION

There currently exists a number of securing systems for glass mounted in a window frame or door frame and having a thin layer of security film. In general terms, the security film is a transparent, multi-layer polymer film that is applied to one surface of the glass, typically the interior surface. The security film reduces the incidence of fragmentation of the glass when the glass is struck or a force is applied to the exterior surface of the glass. Such may occur when a person strikes the glass with a heavy object to initiate a robbery, or when severe weather, such as a tornado or hurricane, propels a foreign object against the glass. In the event the glass is broken, the security film minimizes glass fragmentation which can compromise the security of the building and the health of the persons within the premises. To lessen the likelihood of demounting or detachment of the broken glass and the security film from the frame assembly under severe force conditions, the security film is adhered to all of the exposed glass and then indirectly linked to the frame members which receive the glass in one of two ways. Demounting of the glass and the security film is particularly troublesome because the glass and film can combine as a single mass that is propelled from the frame assembly into the building premises, which can result in significant property damage and/or endanger occupants of the building. Demounting of the glass and security film can occur under high force applications to the glass, such as that caused by severe weather or purposeful explosions.

A first approach to linking the security film to the frame member is mechanical in which a rigid base plate is positioned over both the security film and the frame member. The security film is dimensioned such that it overlaps the frame member. In this manner, the security film extends beyond the borders of the exposed glass and onto the frame members that collectively secure the glass in place. The base plate is then secured with elongated fasteners, such as screws, to the window frame. A decorative cap is then applied to improve the aesthetic appearance and complete the installation. The mechanical base plate approach is suitable for government and/or commercial buildings but not residential applications having multi-pane windows or patio doors. Further, most homeowners find the overall heft and bulk of the base plate aesthetically unpleasant. In addition, the securement provided by the base plate and the fasteners compromises the operation of the window since the window cannot be moved between open and closed positions.

A second approach to securing the security film to the frame member is primarily mechanical in which double-faced adhesive tape and a metal cover strip are utilized. Referring to FIG. 1 of U.S. Pat. No. 5,992,107 to Poirier, a window securing system includes a plurality of distinct adhesive tape strips 30 adhered to the security film 18 and covered by the cover strip 20. The strip 20 has multiple flanges 22, 24 and defines a cavity 28 in which the two tape strips 30 reside. As shown in the embodiments of FIGS. 1-4, the tape strips 30 are distinct segments that are not linked to or continuous with each other. This is evidenced in the interior corner regions of the load transfer strip 20 where the tape strips 30 are not joined and are spaced a distance apart from each other, thereby resulting in a gap between the tape strips 30. It is important to note that no single tape strip 30 is adhered to both the security film 18 and the window frame member 12. Instead, the load transfer strip 20 is the indirect link from the security film 18 through the adhesive strips 30 to the frame member 12. This approach suffers from a number of drawbacks, including difficult installation due to the high-bond adhesive of the tape strip 30. If the tape strip 30 inadvertently contacts the security film 18 prior to reaching its final position, the strip 30 will adhere to the security film 18 and its subsequent removal may remove and/or partially damage the film 18. This necessitates removal of the film 18 and application of a new layer of security film 18, which is costly in terms of materials and labor. In addition, if the load transfer strip 20 is damaged and requires removal, the tape strips 30 are susceptible to being dislodged which leads to the damage of the security film 18. To minimize inadvertent adhesion of the tape strips 30, some installation technicians apply water to the tape strips 30. This reduces the performance of the adhesive of the tape strip 30 and severely compromises the ability of the disclosed system to prevent shattering and/or demounting of the glass when the glass is struck or a force is applied to the exterior surface of the glass. Furthermore, the operational strength of Poirier's system is limited because no single tape strip 30 is adhered to both the security film 18 and the window frame member 12 and only the transfer strip 20 provides the indirect link between the security film 18 and the frame member 12.

The present invention is provided to solve the problems discussed above and other problems, and to provide advantages and aspects not provided by prior glass anchoring systems. A full discussion of the features and advantages of the present invention is deferred to the following detailed description, which proceeds with reference to the accompanying drawings.

### SUMMARY OF THE INVENTION

The present invention is directed to a glass anchoring system that reduces the potential for demounting of glass shattered when a force is applied to the glass or when an object strikes the glass. A pane of glass is positioned within a window frame assembly having a lower frame member, an upper frame member, a first side frame member and a second side frame member. Alternatively, the glass pane is positioned within a door frame assembly formed from a collection of frame members. The window may be openable or stationary, while the door may be a sliding door, such as a patio door, or a door with hinges that pivots about a vertical axis.

According to one aspect of the invention, a layer of security film is applied to a surface of the glass, typically the interior glass surface. The security film is configured such that once it is installed to a surface of the glass, the film has a periphery less than a periphery of the glass. Thus, a border region of the glass is exposed and uncovered by the security film. Alternatively, the security film extends to the edge of the glass pane and/or into the channel of the frame member that receives the glass pane.

According to another aspect of the invention, a structural adhesive mass is applied along the related edge of both the security film and the frame member. The mass is a continuous structure with a first surface that contacts the security film and a second surface that contacts the frame member, wherein the first surface is oriented transversely to the second surface. The mass is substantially triangular in cross-section and wherein the first surface forms a first side of the triangle, the second surface forms a second side of the triangle and the exterior surface forms the third side of the triangle. The first surface is substantially perpendicular to the second surface and the exterior surface forms the hypotenuse of the triangle. The exterior surface of the mass extends diagonally between the first and second surfaces. The mass is formed from silicone, either fluidly dispensed or pre-formed.

According to yet another aspect of the invention, an elongated cover strip is positioned against the exterior surface of the mass, wherein the cover strip has a lower edge portion that contacts the frame member and an upper edge portion that contacts the security film. The cover strip, in cross-section, has a central portion and a lower leg that extends downward from the central portion to define an obtuse external angle, wherein a lower extent of the central portion and the entire lower leg overlie the lower frame member. The central portion and an upper leg that extends upward from the central portion define an obtuse external angle, wherein an upper extent of the central portion and the entire upper leg overlie the security film. Once installed, the mass and the cover strip combine to absorb an amount of the impact force that broke the glass and then dissipate a remaining amount of that force to the frame member to prevent demounting of the glass and the security film.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1A is a perspective view of an anchoring system of the invention, showing a partial window frame assembly, a structural adhesive mass and a cover strip;

FIG. 2A is a partial end view of the anchoring system, showing various components of the window frame assembly, the structural adhesive mass and the cover strip;

FIG. 2B is a schematic view of the structural adhesive mass of the anchoring system;

FIG. 3 is an end view of the cover strip of the anchoring system;

FIG. 4 is a perspective view of a first alternate anchoring system of the invention, showing a partial window frame assembly, a structural adhesive mass and a cover strip;

FIG. 5A is a partial end view of the anchoring system of FIG. 4, showing various components of the window frame assembly, the structural adhesive mass and the cover strip;

FIG. 5B is a schematic view of the structural adhesive mass of the anchoring system of FIG. 4;

FIG. 6 is a cross-section of the cover strip of the anchoring system of FIG. 4;

FIG. 7 is a perspective view of a second alternate anchoring system of the invention, showing a partial window frame assembly, a structural adhesive mass and a cover strip;

FIG. 8A is a partial end view of the anchoring system of FIG. 7, showing various components of the window frame assembly, the structural adhesive mass and the cover strip;

FIG. 8B is a schematic view of the structural adhesive mass of the anchoring system of FIG. 7; and,

FIG. 9 is a cross-section of the cover strip of the anchoring system of FIG. 7.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

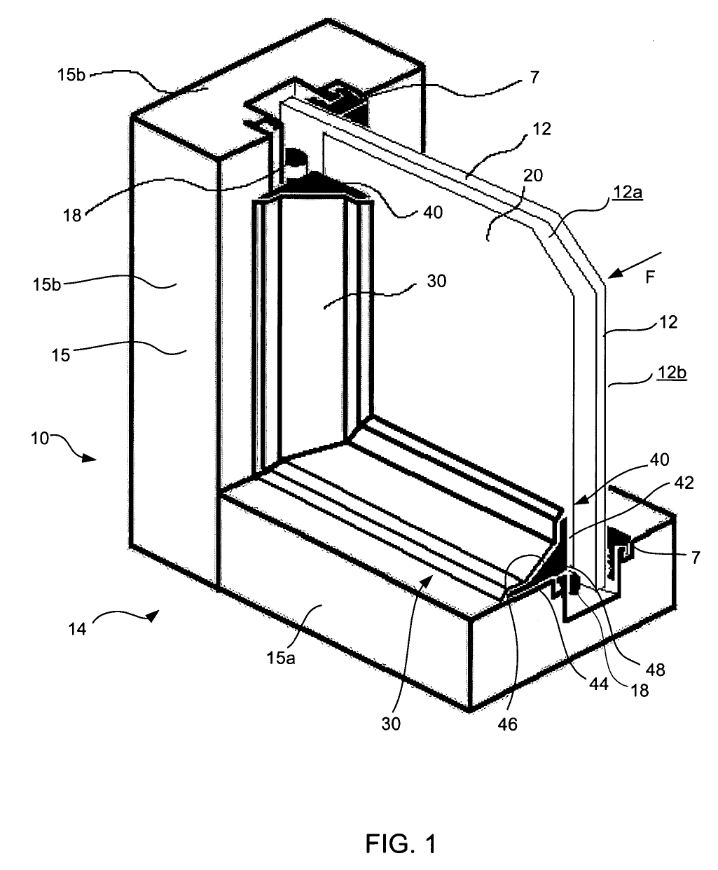

FIGS. 1-6 depict a glass anchoring system 10 that reduces the potential for demounting of the glass 12 when an impact force is applied to the glass 12 or when an object strikes the glass 12. In general terms, a pane of glass 12 is positioned within a window frame assembly 14 formed from a collection of frame members 15, including a lower or horizontal frame member 15a, an upper or horizontal frame member (not shown), a first vertical or side frame member 15b and a second vertical or side frame member (not shown). Alternatively, the glass pane 12 is positioned within a door frame assembly formed from a collection of frame members. The door may be a sliding door, such as a patio door, or a door with hinges that pivot about a vertical axis. The system 10 includes at least one layer of security film 20, a cover strip 30 and an structural adhesive mass 40 applied to both the security film 20 and a portion of the frame member 15. The security film 20 reduces the incidence of shattering of the glass 12 when an impact force F (see FIG. 1A) is applied to the exterior surface of the glass 12. Accordingly, security film 20 is often applied to glass 12 in regions that experience severe weather, such as hurricanes or tornados, which can propel objects against the glass 12. In addition, security film 20 is applied to glass 12 in buildings that have elevated security risks or threat levels, for example government buildings, banks and courts, that may be a target for the detonation of explosives. As explained in greater detail below, the system 10 provides a unique way of anchoring the security film 20 to the frame member 15 and thereby reduces the potential for demounting of the glass 12 and the security film 20 when the impact force F breaks the glass 12.

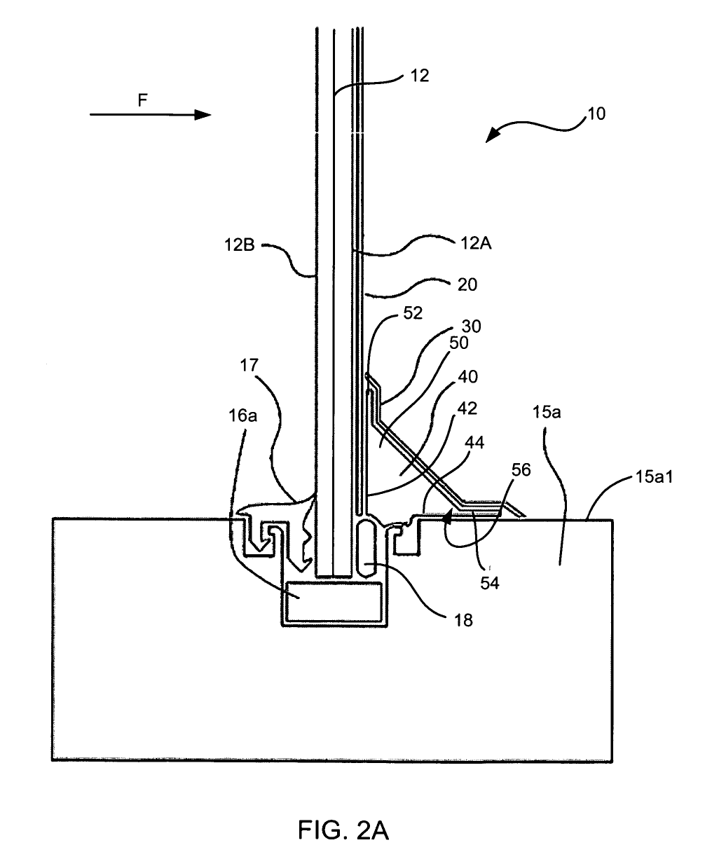

Referring to FIGS. 1 and 2, the frame assembly 14 includes the lower frame member 15a that intersects the side frame member 15b. Each frame member 15 includes a channel or pocket 16 that receives a periphery of the glass 12 and that extends substantially the length of the frame member 15. The channel 16 may include a setting block 16a (see FIG. 2) that engages an edge of the glass 12 for support and positioning purposes. An exterior gasket 17 is positioned adjacent the exterior surface 12b of the glass 12, while the interior gasket is removed and replaced with a “baker rod” or polyester foam element 18. The baker rod 18 helps to stabilize the glass 12 and fill the void within the channel 16 that results from the removal of any glazing material. Also, the baker rod 18 may act as a barricade to prevent seepage of the mass 40 during its application. The setting block 16a, the gasket 17 and the baker rod 18 preferably extend the length of the frame member 15 and the relevant peripheral edge of the glass 12. Although FIG. 1 depicts the lower left region of the system 10, it is understood that the configuration of the glass 12, the security film 20 and the frame assembly 14 is similar in other regions of the system 10. In a similar manner, FIG. 2 is a cross-section of the system 10 with respect to the lower frame member 15a.

The security film 20 is a multi-layer polymer film with an adhesive that is applied to a surface of the glass 12, typically the interior glass surface 12a. As shown in FIGS. 1 and 2, the security film 20 is configured with a periphery or perimeter that is less than that of the glass 12, such that once it is installed to the glass 12, a border region of the glass 12 is exposed and uncovered by the security film 20. Alternatively, the security film 20 extends to the edge of the glass 12 and/or into the channel 16 of the frame member 15 that receives the pane of glass 12. Depending upon a number of installation parameters, including the type of building, the weather conditions, and the security/threat level, the thickness of the film 20 can vary.

The structural adhesive mass 40 is a mass of material applied to both the security film 20 and the frame member 15, thereby linking both structures. This is different from conventional systems where a single adhesive tape element does not contact and/or link both the security film 20 and the frame member 15. Instead, the conventional system requires two or more distinct tape elements to contact and link the film 20 and the frame member 15. Preferably, the mass 40 overlaps an entire edge of the security film 20, meaning from one end of the edge to the other end. Due to the overlap, the mass 40 extends into and beyond a periphery of the film 20 to define an interface region between the film 20 and the mass 40. Described in a different manner and referring to FIG. 1, the mass 40 extends above the lower edge of the film 20 and between the opposed side frame member 15b. The degree or amount of overlap with the film 20 varies with the installation conditions; however, the degree of overlap should be significant enough to ensure adhesion between the mass 40 and the film 20. For residential applications, the amount of overlap or interface between the film 20 and the mass 40 should be at least 0.375 inch, and preferably in the range of 0.375 to 0.625 inch, with 0.5 inch being most preferred. For commercial applications, the amount of overlap or interface should be at least 0.5 inch. Depending upon the installation parameters, the mass 40 may be continuous along its length or segmented, meaning interrupted. In addition to contacting the security film 20, the mass 40 contacts the frame member 15 along its length. As shown in FIGS. 1 and 2A, the mass 40 contacts an upper surface 15a₁ of the lower frame member 15a. In this manner, the mass 40 overlaps a surface of the frame member 15 to connect the security film 20 to the frame member 15. The mass 40 is formed from silicone, either fluidly dispensed or pre-formed. Preferably, the mass 40 is a silicone structural adhesive, such as the Dow Corning® 995 silicone, which has elastomeric properties. If the mass 40 is pre-formed, an installation technician can reduce its dimensions by trimming it to fit the specific dimensions of the film 20 and the frame member 15. In addition to directly connecting the security film 20 to the frame member 15, the mass 40 absorbs and dissipates an initial portion of the impact force F and transfers a remaining portion of the force F to the frame member 15. When the impact force F is large enough to break the glass 12, the system 10, including the mass 40 and the cover strip 30, anchors the glass 12 to the frame assembly 14 to prevent demounting of the glass 12 and film 20.

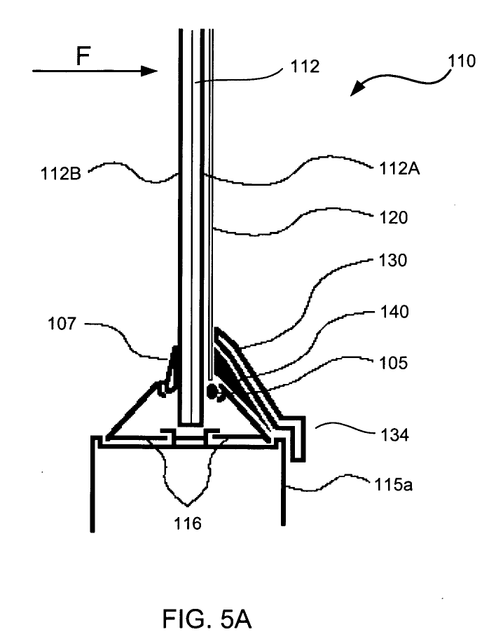

Referring to FIG. 2A, the mass 40 has a generally linear first surface 42 that contacts the security film 20, and a generally linear second surface 44 that contacts the frame member 15, wherein the first surface 42 is oriented transversely to the second surface 44. Preferably, the first and second surfaces 42, 44 extend the length of the mass 40. The mass 40 is generally triangular in cross-section wherein the first surface 42 forms a first side of the triangle, the second surface 44 forms a second side of the triangle and an exterior surface 46 forms the third side of the triangle. Thus, the exterior surface 46 is a diagonal surface that extends between the first and second surfaces 42, 44. In the embodiment of FIGS. 1 and 2A, the first surface 42 is substantially perpendicular to the second surface 44 and the exterior surface 46 forms the hypotenuse of the triangle. Described in a different manner, the mass has an internal longitudinal edge 48 that extends along the length of the mass 40. The first surface 42 extends outward from the edge 48, and the second surface 44 extends outward from the edge 48 to define an internal angle Φ. Depending upon the configuration of the first and second surfaces 42, 44, the internal angle Φ may vary among a right angle (see FIG. 2B), an obtuse angle (see FIG. 5B) and an acute angle. Since the first surface 42 and the second surface 44 extend outward from a common edge—the internal longitudinal edge 48—the mass 40 is continuous from its uppermost point to its outermost point. Consequently, the mass 40 has an appreciable height H that ranges between 0.25 to 1.0 inch for both window and door applications. Preferably, the height H is approximately 0.5 inch for both window and door applications. Also, the mass 40 has an appreciable width W that ranges between 0.25 to 1.0 inch for both window and door applications. Preferably, the width W is approximately 0.5 inch for both window and door applications.

A preferred version of the mass 40 is shown in the schematic of FIG. 2B, wherein the mass 40 includes a central portion 50 within the periphery defined by the first surface 42, the second surface 44 and the exterior surface 46. Also, the mass 40 has a first projection or finger 52 that extends outward from the first surface 42 and the exterior surface 46. The first projection 52 extends upward from the central portion 50 and along a lower extent of the security film 20. The mass 40 further includes a second projection or finger 54 that extends outward from the second surface 44 and the exterior surface 46. In the context of the lower horizontal frame member 15a, the second projection 54 extends along the upper surface or face 15a₁ of the frame member 15a. The exterior surface 46 of the mass 40 extends between the first and second projections 52, 54. Preferably, the exterior surface 46 has a recessed segment 56 that resides inward of the terminus of the first and second projections 42, 44, wherein the recessed segment 56 extends between the first and second projections 52, 54. The recess 56 is configured to receive an extent of the cover strip 30 such that engagement between the mass 40 and the strip 30 is enhanced. Thus, the elongated cover strip 30 directly engages the exterior surface 46 of the mass 40, preferably along the length of the mass 40, and resides in the recessed segment 56. As a result, the cover strip 30 and the mass 40 combine to absorb and transfer the impact force F to the from the glass 12 to the frame member 15, a component of the larger support frame assembly 14, where it can be fully absorbed to prevent demounting of the glass 12. Alternatively, the first and second projections 52, 54 are omitted and the mass 40 is substantially triangular with the first surface 42, the second surface 44 and the exterior surface 46 representing the hypotenuse. The height H of the mass 40 is shown in FIG. 2B as the distance between the second surface 44 and the end of the first projection 52, and the width W is the distance between the first surface 42 and the end of the second projection 54.

Since there are multiple frame members 15 and the security film 20 extends laterally towards the opposed side frame members 15b, a second structural adhesive mass 40 is applied along one of the side frame members 15b between the horizontal frame members 15a. In a similar manner, the second mass 40 has a first surface 42 that contacts the security film 20 and a second surface 44 that contacts the side frame member 15b. A second elongated cover strip 30 is positioned against and engages an exterior surface 46 of the second mass 40 along its length. Referring to FIG. 1, the first cover strip 30 and the second cover strip 30 abut at a corner region of the frame assembly 14. In the context of a door or window, which typically has four frame members 15 that comprise the frame assembly 14 that supports the glass 12, the mass 40 is applied in multiple segments about the multiple edges that define the periphery of the security film 20. Consequently, the number of mass 40 segments corresponds to the number of film 20 edges.

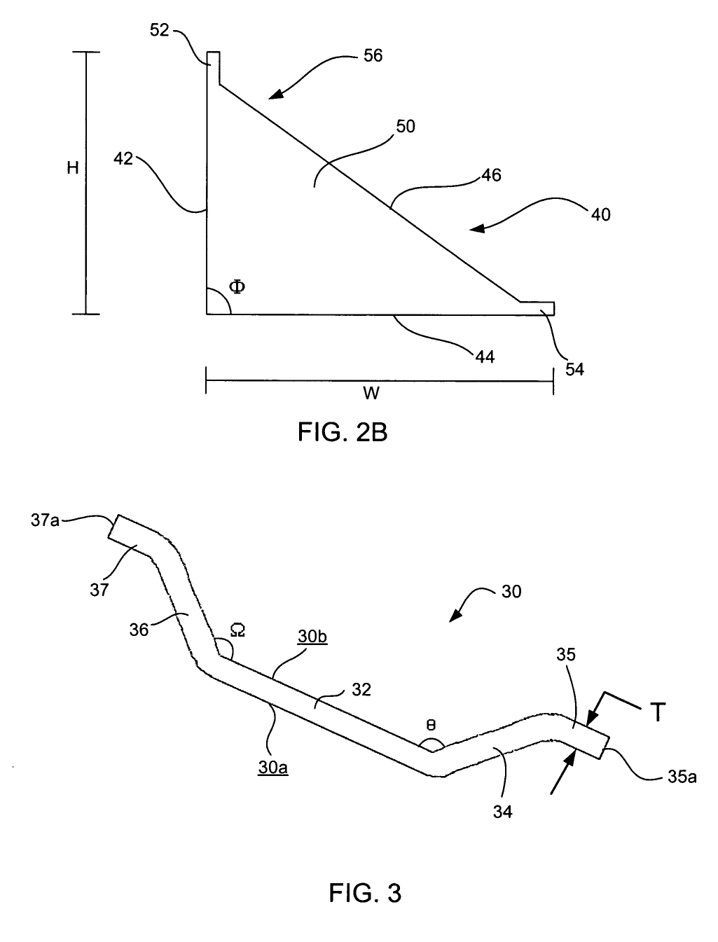

As explained above, the cover strip 30 is an elongated member that overlies, and preferably engages, the structural adhesive mass 40 along its length. Referring to FIG. 3, the cover strip 30 has a central portion 32 and a lower leg 34 that extends from the central portion 32 to define a lower angle θ, which is shown as being obtuse in FIG. 3. Once the cover strip 30 is installed, a lower extent of the central portion 32 and the lower leg 34 overlie a lower portion of the mass 40 and the lower frame member 15a. Furthermore, an upper leg 36 extends from the central portion 32 to define an upper angle Ω. As shown in FIG. 3, the central portion 32 has a length that exceeds the length of either the lower leg 34 or the upper leg 36. In the installed position, an upper extent of the central portion 32 and the upper leg 36 overlie an upper portion of the mass 40 and the security film 20. The lower leg 34 has an extension segment 35 that extends towards the frame member 15a and that has an end wall 35a that engages the frame member 15a in the installed position of FIG. 1. Similarly, the upper leg 36 has an extension segment 37 that extends towards the glass 12 and that has an end wall 37a that engages the security film 20 in the installed position. Once installed, the end wall 35a resides in a plane that is substantially parallel to a plane in which the security film 20 resides, and the end wall 37a resides in a plane that is substantially parallel to a plane in which an upper surface of the lower frame member 15a resides. Preferably, the cover strip 30 and the mass 40 are cooperatively dimensioned such that the central portion 32 and an extent of both the lower and upper legs 34, 36 are received by the recessed segment 56 of the exterior surface 46 to facilitate engagement between the cover strip 30 and the mass 40, wherein the upper leg 36 engages the first or upper mass projection 52 and the lower leg 54 engages the second or lower mass projection 54. An inner strip surface 30a is positioned against the mass 40, while an outer strip surface 30b is exposed or faces inward toward the interior of the building.

Because the elongated cover strip 30 directly engages the exterior surface 46 of the mass 40, preferably along its length, the cover strip 30 provides structural reinforcement between the security film 20 and the frame member 15. In addition to enhancing the rigidity of the mass 40 after installation, the cover strip 30 transfers a portion of the impact force F to the frame member 15. Thus, the mass 40 and the cover strip 30 combine to absorb and transfer the impact force F to the frame member 15 thereby lessening the potential for demounting of the glass 12. The cover strip 30 may be fabricated from vinyl or aluminum, such as aluminum 5005, and may be anodized or powder coated to meet the color specifications of the frame assembly 14. The cover strip 30, in cross-section, has a thickness T (see FIG. 3) ranging from 0.03-0.06 inch, and preferably being 0.04 inch.

While the security film 20 does not prevent breakage of the glass 12, the security film 20 can reduce the incidence of shattering of the glass 12 when the impact force F is sufficient to break the glass 12. However, when the impact force F is significant, such as when an object is driven into the glass 12 by high winds or when an explosion occurs, the security film 20 does not prevent demounting of the glass 12 and the film 20 from the support frame assembly 14. Demounting results in the glass 12 and the film 20 combining as a projectile that is propelled away from the frame assembly 14 and into the interior environment where serious damage to internal structures and/or humans can result. The inventive system 10 dramatically reduces the potential for demounting by adhering or bonding the security film 20 to the frame member 15 and then absorbing and transferring the impact force F to the larger support frame assembly 14, through frame member 15, where it is safely muted. As explained above, the mass 40 and the cover strip 30 form a rigid composition that securely adheres the security film 20 to the frame member 15. When the impact force F is severe, the mass 40 and the cover strip 30 act together to absorb an initial portion of the impact force F and then transfer a remaining portion of the impact F to the frame member 15 and the larger support assembly 14, where it can be completely absorbed to prevent demounting. Accordingly, the combination of the mass 40 and the cover strip 30 provides multiple functions—adhesion, as well as effective impact force absorption and transfer—that are not present in conventional systems. Accordingly, the inventive system 10 enjoys structural and functional distinctions over existing systems that allow the system 10 to dramatically reduce the occurrence of demounting when a severe impact force is applied to the glass 12.

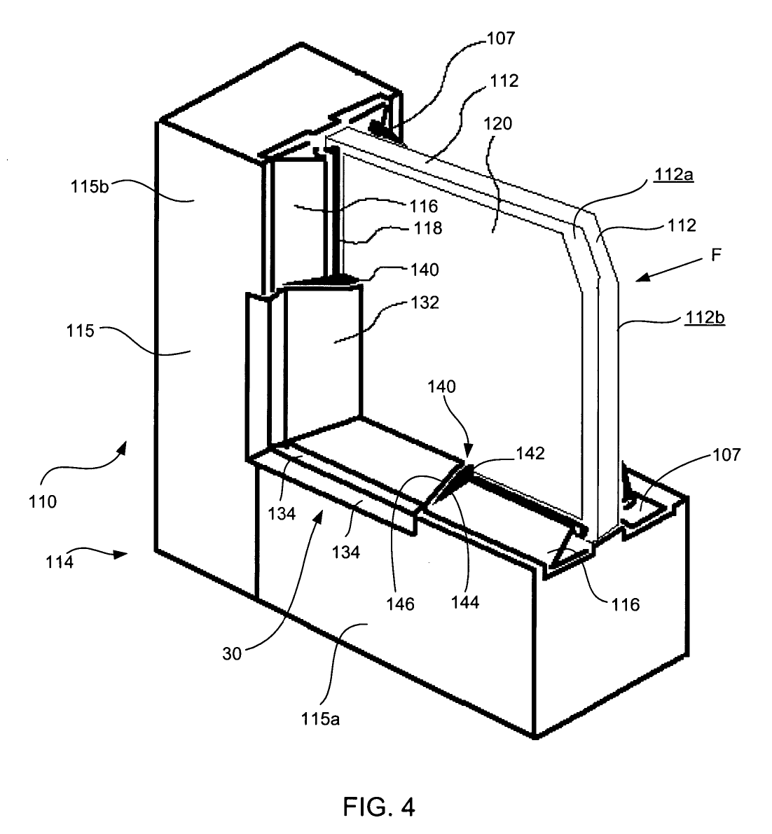

An alternate anchoring system 110 is shown in FIGS. 4-6 in the environment of a commercial door assembly 114. The door assembly 114 includes a plurality of frame members 115, each having a gasket 107 and molding 116 positioned about the glass 112. The anchoring system 110 includes a security film 120, a cover strip 130 and an structural adhesive mass 140 that function in a similar manner to that explained above. However, the structural aspects of these components differ from the components in the anchoring system 10 in the following ways. Unlike the triangular mass 40 of the previous embodiment, the mass 140 has four angled segments. Along those lines, the structural adhesive mass 140 has a generally linear first surface 142 that contacts the security film 120, and a generally linear second surface 144 that contacts the frame member 115 including the molding 116, wherein the first surface 142 is oriented transversely to the downwardly sloped second surface 144. The exterior portion of the mass 140 includes a first exterior surface segment 146 and a second exterior surface segment 147, that combine to define a first internal angle Ψ that is obtuse. Thus, the exterior surfaces 146, 147 combine to extend between the first and second surfaces 142, 144. Alternatively, one or both of the exterior surface 146, 147 are curvilinear or bulbous. The first surface 142 extends outward from the an internal longitudinal edge 148 and the second surface 144 extends outward from the edge 148 to define an internal angle Φ. As shown in FIGS. 5A and B, the second internal angle Φ is obtuse.

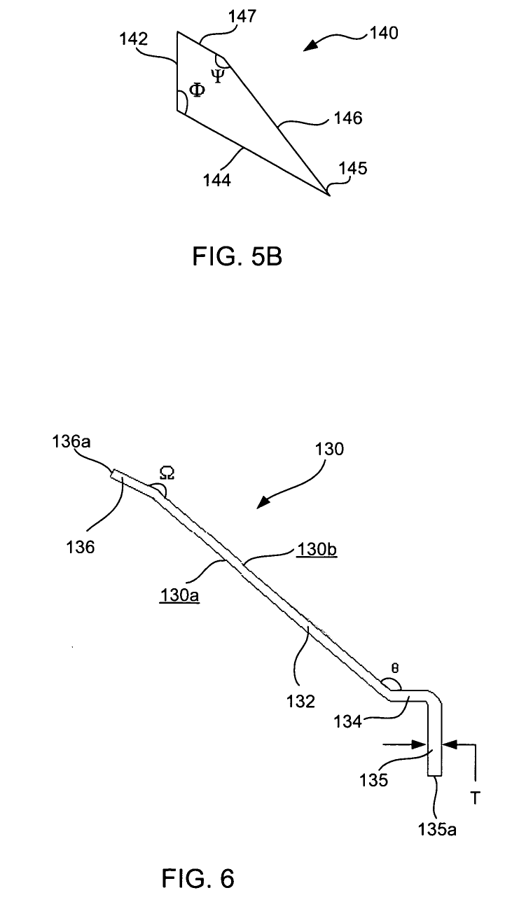

The cover strip 130 overlies, and preferably engages, the structural adhesive mass 140 along its length. Referring to FIGS. 5A and 6, the cover strip 130 is multi-faceted with a central portion 132 and a peripheral or lower leg 134 that extends from the central portion 132 to define a lower external angle θ, which is shown as being obtuse in FIG. 6. Once the cover strip 130 is installed, a lower extent of the central portion 132 and the lower leg 134 overlie a lower portion of the mass 140 and the lower frame member 115a. Furthermore, an upper leg 136 extends from the central portion 132 to define an upper external angle Ω, which is shown as obtuse. In the installed position, an upper extent of the central portion 132 and the upper leg 136 overlie an upper portion of the mass 140 and the security film 120. The lower leg 134 has a notched configuration with a substantially downward directed segment 135 that overlaps an upper portion of the front face of the frame member 115a in the installed position of FIG. 4A. The cover strip 130, in cross-section, has a thickness T ranging from 0.03-0.06 inch, and preferably 0.04 inch.

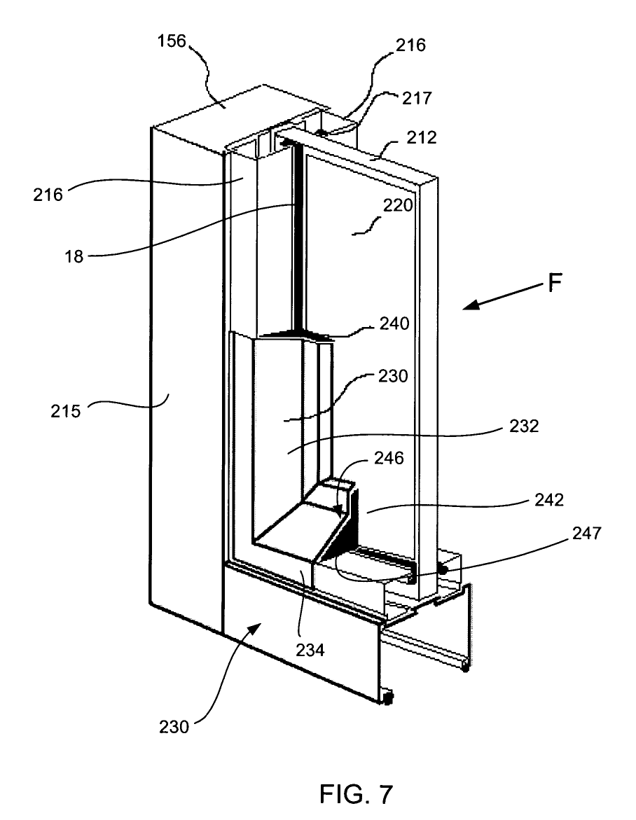

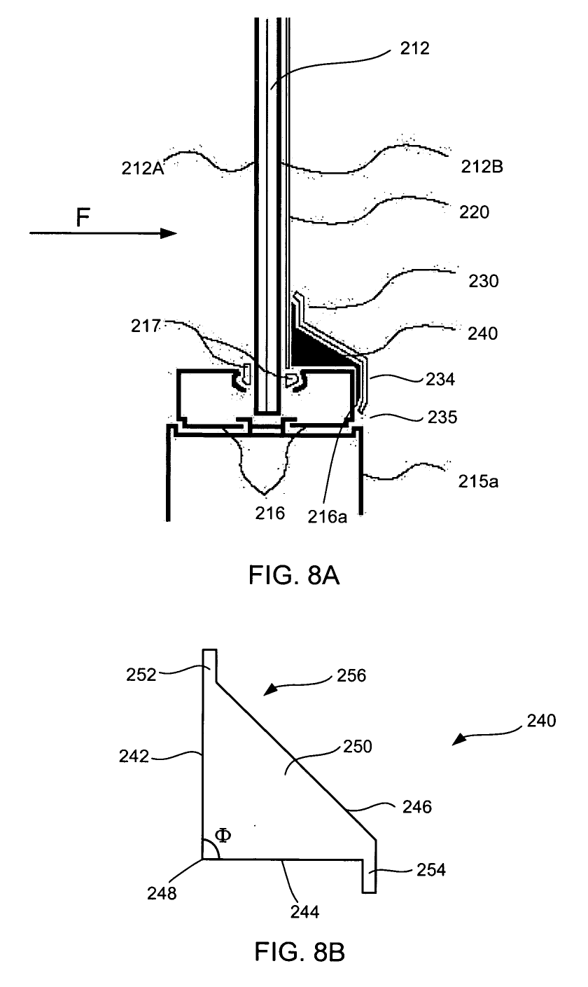

An alternate anchoring system 210 is shown in FIGS. 7-9 in the environment of a commercial door assembly 214. The door assembly 214 includes a plurality of frame members 215, each having a gasket 207 and molding 216 positioned about the glass 212. The anchoring system 210 includes at least one layer of security film 220, a cover strip 230 and an structural adhesive mass 240 that function in a similar manner to that explained above. However, the structural aspects of these components differ from the components in the anchoring system 10 in the following ways. The structural adhesive mass 240 has a generally linear first surface 242 that contacts the security film 220, and a generally linear second surface 244 that contacts the frame member 215 including the molding 216, wherein the first surface 242 is oriented transversely to the second surface 244. The exterior portion of the mass 240 includes an exterior surface 246 that extends between the first and second surfaces 242, 244. Although shown as being substantially linear, the exterior surface 246 may be curvilinear or bulbous. The first surface 242 extends outward from an internal longitudinal edge 248 and the second surface 244 extends outward from the edge 248 to define an internal angle Φ. As shown in FIGS. 8A and B, the internal angle Φ is substantially ninety degrees or a right angle.

In addition, the mass 240 has a first projection or finger 252 that extends outward from the first surface 242 and the exterior surface 246. The first projection 252 extends upward from the central portion 250 and along a lower extent of the security film 220. The mass 240 further includes a second projection or finger 254 that extends outward from the second surface 244 and the exterior surface 246. In the context of the lower horizontal frame member 215a, the second projection 254 extends downward along the outer surface or face 216a of the molding 216. The exterior surface 246 of the mass 240 extends between the first and second projections 252, 254. Preferably, the exterior surface 246 has a recessed segment 256 that extends between the first and second projections 252, 254. The recess 256 is configured to receive an extent of the cover strip 230 such that engagement between the mass 240 and the strip 230 is enhanced. Thus, the elongated cover strip 230 directly engages the exterior surface 246 of the mass 240, preferably along the length of the mass 240, and resides against the recessed segment 256. As a result, the cover strip 230 and the mass 240 combine to absorb and transfer the impact force F to the from the glass 212 to the molding 216 which is connected to the frame member 215 and the larger support frame assembly 214, where it can be fully absorbed to prevent demounting of the glass 212.

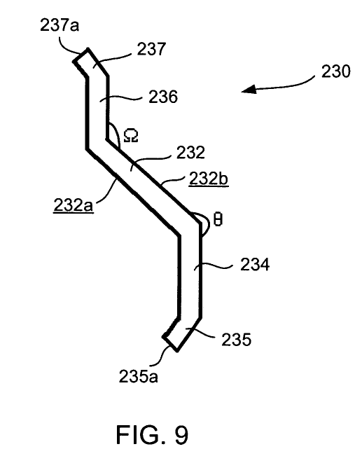

The cover strip 230 overlies, and preferably engages, the structural adhesive mass 240 along its length. Referring to FIGS. 8A and 9, the cover strip 230 is multi-faceted with a central portion 232 and a peripheral or lower leg 234 that extends from the central portion 232 to define a lower external angle θ, which is shown as being obtuse in FIG. 9. The lower leg 234 has an extension segment 235 that extends inward towards the outer face 216a of the molding 216. The extension segment 235 has an end wall 235a that may engage the outer face 216a in the installed position. Once the cover strip 230 is installed, a lower extent of the central portion 232 and the lower leg 234 overlie an outer face 216a of the molding 216. Furthermore, an upper leg 236 extends from the central portion 232 to define an upper external angle Ω, which is shown as obtuse. The upper leg 236 has an extension segment 237 that extends inward towards the glass 212 and that has an end wall 212a that may engage the security film 220 in the installed position. In the installed position, an upper extent of the central portion 232 and the upper leg 236 overlie an upper portion of the mass 240 and the security film 220.

While the specific embodiments have been illustrated and described, numerous modifications come to mind without significantly departing from the spirit of the invention, and the scope of protection is only limited by the scope of the accompanying Claims.

1. A glass anchoring system to prevent the demounting of the glass from a support frame assembly, the frame assembly having a lower frame member, an upper frame member, a first side frame member and a second side frame member, the anchoring system comprising:
a layer of security film applied to a surface of the glass;
a structural adhesive mass applied along the lower frame member between the first and second side frame members, the mass having a first surface that contacts the security film and a second surface that contacts the lower frame member, the first surface being oriented transversely to the second surface, wherein the mass adheres the security film to the lower frame member; and,
an elongated cover strip that engages an exterior surface of the mass along the length of the mass, the cover strip having both an upper end that contacts the security film and a lower end that contacts the lower frame member.

2. The anchoring system of claim 1, wherein the mass is substantially triangular in cross-section and wherein the first surface forms a first side of the triangle, the second surface forms a second side of the triangle and the exterior surface forms the third side of the triangle.

3. The anchoring system of claim 1, wherein the first surface, the second surface and the exterior surface collectively define a central portion of the mass, and wherein the mass has a first projection that extends outward from the central portion and along the security film.

4. The anchoring system of claim 3, wherein the mass has a second projection that extends outward from central portion and along the lower frame member.

5. The anchoring system of claim 3, wherein the exterior surface of the mass extends between the first and second projections, the exterior surface having a recessed segment that receives an extent of the cover strip in an installed position.

6. The anchoring system of claim 1, further comprising a second structural adhesive mass applied along one of the side frame members between the upper and lower frame members, the second mass having a first surface that contacts the security film and a second surface that contacts the side frame member, the first surface being oriented transversely to the second surface, wherein the second mass adheres the security film to the side frame member.

7. The anchoring system of claim 6, further comprising a second elongated cover strip that engages an exterior surface of the second mass along the length of the second mass, wherein the first cover strip and the second cover strip abut at a corner region of the frame assembly.

8. A glass anchoring system that reduces the occurrence of demounting of the glass from a support frame assembly, the anchoring system comprising:
a pane of glass secured within a frame assembly defined by an arrangement of frame members;
a layer of security film applied to a surface of the glass; and,
a structural adhesive mass positioned along a lower frame member and extending continuously between opposed side frame members, the mass having a first interior surface that contacts the security film and a second interior surface that contacts the lower frame member, wherein the mass adheres the security film to the lower frame member; and,
wherein the first surface and the second surface extend outward from an internal longitudinal edge of the mass and the first surface is oriented transversely to the second surface.

9. The anchoring system of claim 8, wherein the first surface is substantially perpendicular to the second surface.

10. The anchoring system of claim 8, wherein the first and second surfaces define an internal angle of the mass that is obtuse.

11. The anchoring system of claim 8, further comprising an elongated cover strip that engages an exterior surface of the mass in an installed position.

12. The anchoring system of claim 11, wherein the cover strip, in cross-section, has a central portion and a lower leg that extends from the central portion to define an obtuse external angle, wherein a lower extent of the central portion and the entire lower leg overlie the lower frame member.

13. The anchoring system of claim 11, wherein the cover strip, in cross-section, has a central portion and an upper leg that extends from the central portion to define an obtuse external angle, wherein an upper extent of the central portion and the entire upper leg overlie the security film.

14. The anchoring system of claim 8, wherein the structural adhesive mass is a silicone sealant.

15. An anchoring system to reduce the likelihood of glass demounting from a support frame assembly defined by an arrangement of frame members, the anchoring system comprising:
a layer of security film applied to a surface of the glass;
a structural adhesive mass applied to an extent of the security film and along a frame member, the mass having an exterior surface, a first surface that contacts the security film and a second surface that contacts the frame member;
an elongated cover strip positioned against the exterior surface of the mass, the cover strip having a lower edge portion that contacts the frame member and an upper edge portion that contacts the security film; and,
wherein the mass and the cover strip combine to adhere the security film to the lower frame member, and wherein the combined mass and cover strip absorb a first portion of an impact force applied to an outer surface of the glass and then transfer a second portion of the impact force to the frame member.

16. The anchoring system of claim 15, wherein the mass is preformed with a length that can be reduced to correspond to a length of the frame member by an operator.

17. The anchoring system of claim 15, wherein the mass is substantially triangular in cross-section and wherein the first surface forms a first side of the triangle, the second surface forms a second side of the triangle and the exterior surface forms the third side of the triangle.

18. The anchoring system of claim 15, wherein the first surface, the second surface and the exterior surface collectively define a central portion of the mass, and wherein the mass has a first projection that extends outward from the central portion and along the security film.

19. The anchoring system of claim 18, wherein the mass has a second projection that extends outward from central portion and along the frame member.

20. The anchoring system of claim 15, wherein the upper edge portion of the cover strip includes an end wall that engages a portion of the security film, wherein the end wall resides in a plane that is parallel to a plane in which the security film resides.

21. The anchoring system of claim 20, wherein the lower edge portion of the cover strip includes an end wall that engages a portion of the frame member, wherein the end wall resides in a plane that is parallel to a plane in which an upper surface of the frame member resides.

22. An anchoring system to reduce the likelihood of glass demounting from a support frame assembly defined by an arrangement of frame members, the anchoring system comprising:
a layer of security film applied to a surface of the glass;
a structural adhesive mass applied to an extent of the security film and along a frame member, the mass having an exterior surface, a first surface that contacts the security film and a second surface that contacts the frame member, wherein the first surface, the second surface and the exterior surface collectively define a central portion of the mass, and wherein a first projection extends from the central portion and along an outer face of the frame member;
an elongated cover strip positioned against the exterior surface of the mass, the cover strip having a central portion, a lower leg that extends from the central portion and an upper leg that extends from the central portion; and,
wherein the mass and the cover strip combine to adhere the security film to the frame member.

23. The anchoring system of claim 22, wherein the combined mass and cover strip absorb a first portion of an impact force applied to an outer surface of the glass and then transfer a second portion of the impact force to the frame member.

24. The anchoring system of claim 22, wherein a second projection extends from the central portion and along the security film.

25. The anchoring system of claim 22, wherein the first surface and the second surface intersect to form an internal angle that is substantially 90 degrees.

26. The anchoring system of claim 22, wherein the mass is a pre-formed solid that can be trimmed to reduce its length.

27. The anchoring system of claim 22, wherein the cover strip is fabricated from plastic.

28. The anchoring system of claim 22, wherein the lower leg and the central portion intersect to define an internal angle that is substantially 90 degrees.

29. The anchoring system of claim 22, wherein the upper leg and the central portion intersect to define an internal angle that exceeds 90 degrees.

30. The anchoring system of claim 22, wherein the lower leg of the cover strip has an end wall that contacts the frame member, and the upper leg has an end wall that contacts the security film.
